(19) United States
(12) Patent Application Publication
(10) Pub. No.: US 2022/0177110 A1
(43) Pub. Date: Jun. 9, 2022

(54) COCKPIT DOOR SECURITY SYSTEM

(71) Applicant: Airbus Canada Limited Partnership, Mirabel (CA)

(72) Inventors: Mark MATHIEU, MIRABEL (CA); Marc-Andre LEDUC, MIRABEL (CA)

(21) Appl. No.: 17/539,562

(22) Filed: Dec. 1, 2021

(30) Foreign Application Priority Data
Dec. 8, 2020 (CA) 3101899

(51) Int. Cl. B64C 1/14; B64D 45/00

(52) U.S. Cl. CPC B64C 1/1469; B64D 45/0029; B64D 45/0026

(57) ABSTRACT

There is provided a system for securing a cockpit from a cabin. A lavatory door has a locking mechanism provided thereon. A latching mechanism is provided on an adjacent structure across an aisle from the lavatory. The locking mechanism is compatible with the latching mechanism to secure the lavatory door in an open position, thereby forming a secure area for entering from the cockpit.

### CROSS-REFERENCES TO RELATED APPLICATIONS

This application claims the benefit of the Canadian patent application No. 3101899 filed on Dec. 8, 2020, the entire disclosures of which are incorporated herein by way of reference.

### FIELD OF THE INVENTION

In general, this disclosure relates to a system for securing a door for a cockpit or flight deck for access to the lavatory or a rest area. More preferably, the system uses a lavatory door to secure the rest area.

### BACKGROUND OF THE INVENTION

There are many concerns surrounding aircraft safety. One of the more recently emphasized concerns involves ensuring safety from hijackers or those desiring harm from within an aircraft. More particularly, protection of the pilot and those in the flight deck is of prime importance.

Recently, airlines have secured the flight deck by installing stronger doors and locking mechanisms that cannot be forced open from the outside. Such measures have been problematic, however, since there are routine times when a member of the flight deck crew will need to open the door to use the lavatory or for other matters. The strength of the door does not hinder a hijacker who will wait for the door to open and then quickly enter the flight deck. Once inside, the strength of the door protects the hijacker and prevents others from entering.

Other forms of securing the flight deck involve installing a second permanently fixed door to prevent passengers from determining when the flight deck door is open; however, such a measure is suboptimal since it takes up space and involves additional cost.

U.S. Patent Publication No. 2005116098 teaches a securable curtain which can be closed around the flight deck door. When not in use, the curtain can be opened to provide more space.

A security partition is provided in U.S. Publication No. 20100288881 which includes a flight deck connected to an accommodation room having a lounge and lavatory.

Other types of securing mechanisms have been contemplated, such as taught in U.S. Pat. No. 7,984,875 wherein the flight deck door has a latching mechanism and hinge system such that the flight deck door swings open to engage with a flight deck bulkhead in one position, and a lavatory bulkhead in a second position so that flight deck crew can safely enter the lavatory from the flight deck while the flight deck door is in the second position. The flight deck door runs along the lavatory door such that the lavatory bulkhead must be positioned right next to the flight deck bulkhead.

U.S. Pat. No. 6,702,231 describes a secure door system for a cockpit of an aircraft. This system includes a frame connected to an interior wall of an aircraft, such that the frame can move from a first configuration in an insecure area to a second configuration in a secure area. The cockpit door is accessible in the first configuration and is not accessible in the second configuration. Drawbacks include the weight of the frame, door and hinge configuration along with the complications of such a system. Two different hinges are required as well as many additional elements, such as locks and lock receivers.

Flight regulations are in the process of receiving updates to include new requirements for a flight deck access security secondary barrier. The regulations require a secondary barrier to be positioned between the cabin and the lavatory for the pilots to access the lavatory without risk of an intruder penetrating the secure area of the cockpit.

### SUMMARY OF THE INVENTION

There is provided herein a system which uses the lavatory door and/or a secondary door to block access to an area between the forward lavatory and the cockpit from the cabin. The system minimizes cost and weight impact and provides a simple and effective secure locking system for the cockpit. When a member of the flight crew leaves the cockpit to use the lavatory, the cockpit door serves as a privacy door and can be manually locked from the cabin/lavatory side. The system is independent of the type of door and can use a single blade door or a bifold door, for example.

### BRIEF DESCRIPTION OF THE DRAWINGS

The invention will be further understood from the following description with reference to the attached drawings.

FIG. 1 illustrates a top view of a portion of an aircraft showing the arrangement of the flight deck door and lavatory door with a secondary door.

FIG. 2 illustrates a top view of a portion of an aircraft showing the opening of the flight deck door when the lavatory locking mechanism is in place.

FIG. 3 illustrates a top view of a portion of an aircraft showing the arrangement of the flight deck door and lavatory door without a secondary door.

### DETAILED DESCRIPTION OF THE PREFERRED EMBODIMENTS

The exemplary embodiments of the present disclosure are described and illustrated below to encompass a secure cockpit door system, for example purposes only. Of course, it will be apparent to those of ordinary skill in the art that the embodiments discussed below are exemplary in nature and may be reconfigured without departing from the scope and spirit of the present disclosure. However, for clarity and precision, the exemplary embodiments as discussed below may include optional steps, methods, and features that one of ordinary skill should recognize as not being a requisite to fall within the scope of the present disclosure.

In one example embodiment, the system uses a lavatory door to separate the aircraft cabin from the lavatory/flight deck area. When the lavatory door is opened, it is latched to a monument across the aisle from the lavatory. If the lavatory door is too short because the monument is too far, the lavatory door is latched to a secondary door attached to the monument. After the door is secured and locked, a pilot can open the flight deck door, exit the flight deck, close and manually lock the flight deck door and use the lavatory. Privacy is provided via the cockpit door and lavatory door.

In a further example embodiment, the secondary door can be locked to the floor and/or to the ceiling to secure the open position. In one embodiment, the secondary barrier door is fixed to the monument facing the lavatory.

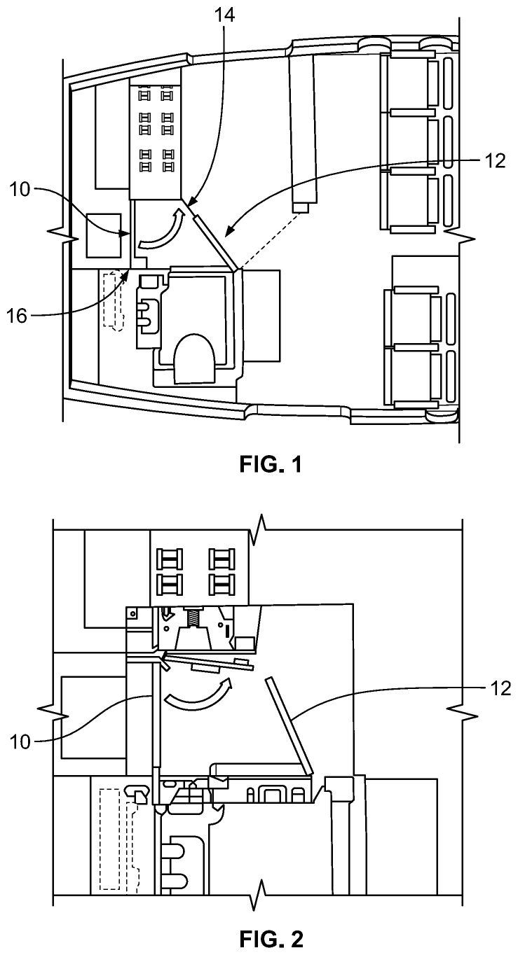

FIG. 1 shows a top view of an aircraft showing a portion of the flight deck or cockpit and cabin. The flight deck door 10 is shown in a closed and locked position. The lavatory door 12 is shown in three optional positions: closed against the lavatory (first optional position), open at a first angle connected with the first monument closest to the flight deck (second optional position) and open at a second angle connected with a second monument closest to the cabin section (third optional position). An optional secondary barrier door 14 is shown attached to the first monument. Any such secondary barrier door could also be provided at the second monument if necessary. A door locking device 16 that is accessible from the outside is shown such that when a member of the flight crew leaves the cockpit to use the lavatory, the flight deck door 10 serves as a privacy door and can be manually locked from the cabin/lavatory side using the door locking device 16.

The third optional position of the lavatory door 12 could enable a member of the flight crew to access a refreshment or optional lounge area.

FIG. 2 shows the ability of the flight deck door 10 to open while the lavatory door 12 locking mechanism is in place.

In one example embodiment, the lavatory door 12 is able to open at an angle suitable to contact the secondary barrier door 14. Both the lavatory door and the secondary barrier door are equipped with compatible locking devices so as to prevent uncoupling provided a pilot is in the secured area. Any type of suitable locking device can be used. For example, an electronic locking device can be provided which can only be locked or unlocked by either the pilot or a cabin crew member through a password. As a further example, a password could be entered into a dedicated locking system or into an existing surveillance system through input device such as keypad. Other suitable locking mechanisms can be utilized, such as traditional key locks, smart keys, pattern locks, or a biometric lock using fingerprints or facial recognition.

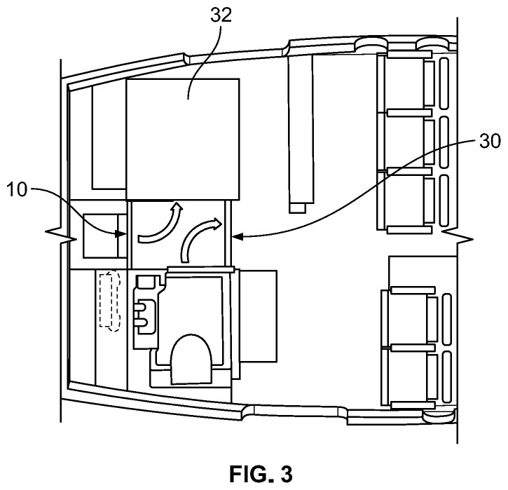

If there is no need for a secondary door because of the full size of the opposite monument or the full size of the lavatory door 12 extending to reach the first monument, solely the lavatory door is used to close the secured area without a secondary door. Such an embodiment is illustrated in FIG. 3. In such an example embodiment, a locking mechanism secures the sole lavatory door 30 directly to the monument 32, such that the compatible locking devices are provided on the lavatory door 30 and the monument 32. The flight deck door 10 can be opened once the sole lavatory door 30 is secured.

In one example use of the system, a member of the flight crew communicates a request to a cabin crew member to actuate the lavatory door locking mechanism. Upon receipt of an indication that the lavatory door locking mechanism is in place, the cockpit door can be opened so that the flight crew member can access the lavatory privately and without any risk of intrusion. The communication of the request to the cabin crew member can be performed by any form of communication, such as audio, video, a flashing light, text, etc.

It will be appreciated by one skilled in the art that variants can exist in the above-described arrangements and applications. For example, the extent, location and reach of the lavatory door and/or monuments can vary. The drawings are mere illustrations and lavatories could be provided in a different orientation or on a different side of the aircraft while still operating within the scope of the invention. The lavatory door and/or flight deck door can be reversible. Similarly, although the invention has been described with respect to an example embodiment of an aircraft lavatory, the invention can be applied to lavatories in other types of scenarios such as trains.

Following from the above description, it should be apparent to those of ordinary skill in the art that, while the methods and apparatuses herein described constitute exemplary embodiments of the present invention, the invention described herein is not limited to any precise embodiment and that changes may be made to such embodiments without departing from the scope of the invention as defined by the claims. Consequently, the scope of the claims should not be limited by the preferred embodiments set forth in the examples but should be given the broadest interpretation consistent with the description as a whole. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for securing a cockpit from a cabin, comprising:
a locking mechanism provided on a door of a lavatory; and
a latching mechanism provided on an adjacent structure across an aisle from the lavatory;
wherein the locking mechanism is compatible with the latching mechanism to secure the lavatory door in an open position.

2. The system of claim 1 wherein the adjacent structure is a monument.

3. The system of claim 1 wherein the adjacent structure is a secondary door that is secured to a monument.

4. The system of claim 1 further comprising a second latching mechanism on a second adjacent structure; and
wherein the locking mechanism is compatible with the second latching mechanism to secure the lavatory door in a second open position.

5. The system of claim 4 wherein the second adjacent structure is a monument.

6. The system of claim 4 wherein the second adjacent structure is a secondary door that is secured to a monument.

7. The system of claim 1 further comprising a communication device between the cockpit and the cabin which alerts crew in the cabin to secure the lavatory door.

8. The system of claim 7 wherein the communication device uses a form of communication selected from the group consisting of audio, video, text and flashing light.

9. The system of claim 1 wherein the locking mechanism and latching mechanism use a locking system selected from the group consisting of passwords, keys, smart keys, pattern locks, and biometric locks.

10. A system for securing a cockpit from a cabin, comprising:
a flight deck door;
a lavatory door having a locking mechanism; and
a latching mechanism provided on an adjacent structure across an aisle from the lavatory door;
wherein the locking mechanism is compatible with the latching mechanism to secure the lavatory door in an open position; and
wherein the flight deck door is openable once the lavatory door is secure.

11. The system of claim 10 wherein the flight deck door comprises an external lock that can be locked from the cabin.

12. The system of claim 11 wherein the locking mechanism and latching mechanism use a locking system selected from the group consisting of passwords, keys, smart keys, pattern locks, and biometric locks.

13. The system of claim 11 wherein the external lock uses a locking system selected from the group consisting of passwords, keys, smart keys, pattern locks, and biometric locks.

14. A method for securing a cockpit from a cabin, comprising the steps of:
opening a door of a lavatory having a locking mechanism;
securing the locking mechanism of the lavatory door to an adjacent structure across an aisle from the lavatory, the adjacent structure having a compatible latching mechanism;
opening a cockpit door to access the lavatory; and
locking the cockpit door to secure the lavatory.

15. The method for securing a cockpit from a cabin of claim 11, further comprising the step of sending a communication from the cockpit to the cabin to request securing of the lavatory door.
